(19) United States
(12) Patent Application Publication
(10) Pub. No.: US 2008/0178694 A1
(43) Pub. Date: Jul. 31, 2008

(54) DYNAMIC ENVIRONMENT MEASUREMENTS

(76) Inventors: Lee A. Barford, San Jose, CA (US); Lee H. Ng, Palo Alto, CA (US); Jefferson B. Burch, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/627,136

(22) Filed: Jan. 25, 2007

(51) Int. Cl. G01D 21/00

(52) U.S. Cl. 73/866.5

(57) ABSTRACT

A movable sensor assembly has a resting position proximate to a top surface of an environment to be measured. The sensor assembly includes a sensor that measures an environmental parameter. A spool has an end of line connecting to the sensor. An actuator connects to the spool operative to extend and retract the line. A controller provides control information to the sensor and the actuator. The environmental parameter is selected from a group that includes light, chemical composition, air speed, air velocity, and sound.

### BACKGROUND

Measurements of a room, e.g. air quality measurements such as temperature, humidity, carbon dioxide concentration, are taken in fixed positions. The sensor may be mounted, lying on the walls, or placed on furniture. Since the measurements are not taken where the occupants may be, the measured values may be inaccurate. More accurate measurements may be achieved by having a hand held measurement device positioned precisely in the location of interest. However, such devices are expensive and the results cannot be reproduced reliably.

### SUMMARY

A movable sensor assembly has a resting position proximate to a top surface of an environment to be measured. The sensor assembly includes a sensor that measures an environmental parameter. A spool having an end of line connecting to the sensor. A movement controller connected to the spool operative to extend and retract the line. A controller providing control information to the sensor. The environmental parameter is selected from a group that includes light, chemical composition, air speed, air velocity, and sound.

### BRIEF DESCRIPTION OF THE DRAWINGS

FIG. 1 illustrates a block diagram of the sensor assembly of the invention.

FIG. 2 illustrates a flowchart for the measurement process using the sensor assembly shown in FIG. 1.

### DETAILED DESCRIPTION

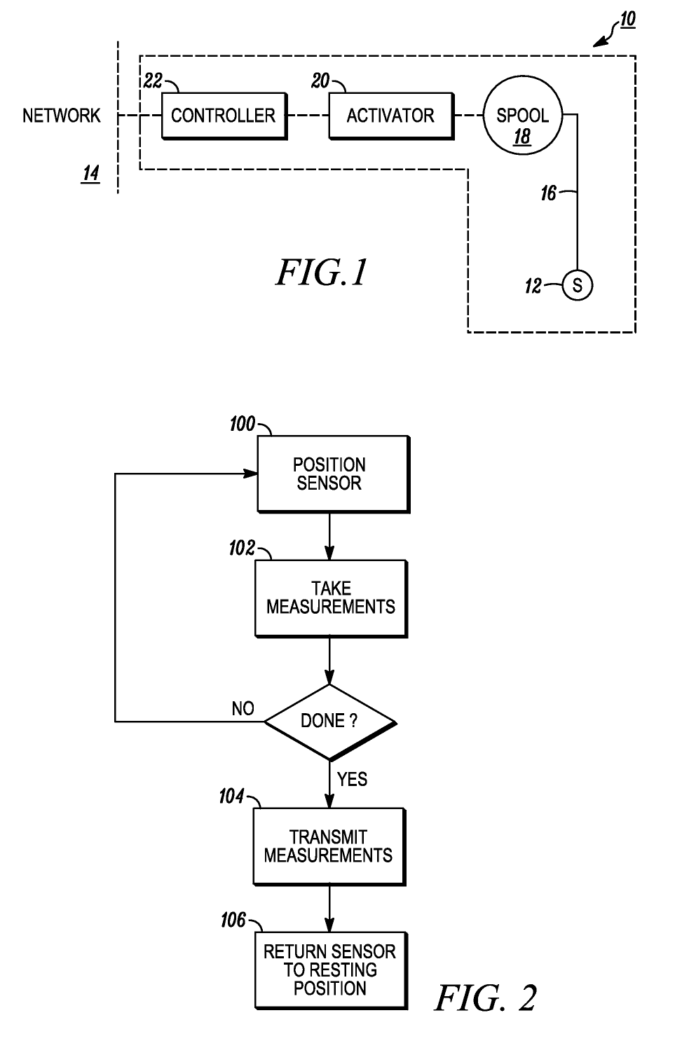

FIG. 1 illustrates a block diagram of the sensor assembly of the invention 10. At least one sensor 12 is connected to a central controller (not shown) using a wireless or wired network 14. The sensor 12 is physically connected to a thin lightweight line 16, e.g. light breaking strength fishing line. The line 16 is wrapped around a small spool 18. The spool 18 is turned by an actuator 20. A controller 22, e.g. an application specific integrated circuit (ASIC), microprocessor, programmable hardware such as a field programmable gate array (FPGA), or the like, interfaces to the network 14, controls the actuator 20 and the sensor 12, receives measurements from the sensor 12, and transmits measurements to other devices and systems via the network 14. Optionally, the controller 22 performs calibration correction, conversion from analog to digital converter to physical units, and/or provides a Transducer Electronic Data Sheet (TEDS) such as that specified by IEEE Standard 1451.2.

The sensor 12 may be any small sensor, e.g. MEMS sensor, which can measure a parameter that is dispersed in the environment. Such parameters include light, chemical composition, air speed or velocity, temperature, humidity, and sound. Alternatively, the sensor 12 may include a supercap or conventional capacitor or a small battery that is recharged when the sensor is at its topmost position so that it need not be connected to power and ground while taking measurements.

The sensor assembly 10 is attached or incorporated into the bottom of a fixture commonly installed in the ceiling of the room, e.g. lighting fixtures, inlet or outlets to HVAC ducting, smoke/fire alarm sensors. Alternatively, the sensor assembly 10 may be attached to a ceiling, the bottom or sides of a roof truss, drop ceiling supports, or other structural or non-structural building components well above the floor. The sensor assembly 10 will generally draw power from the fixture in which it is incorporated

The actuator 20 may be a small motor, a solenoid, or the like.

In operation, the sensor assembly 10 is positioned close to the ceiling-mounted device not to interfere with the normal use of the room. FIG. 2 illustrates a flowchart indicating the measurement process. When a measurement is to be taken, in step 100, the controller commands the actuator to lower the sensor to the desired height and the actuator does so. Next in step 102, the controller sends a control signal to the sensor to take the measurement. Steps 100 and 102 may be repeated to acquire a vertical profile of the measured parameter. In step 104, the measurements are reported over a wireless or wired network. In step 106, the controller returns the sensor to its resting position.

While the invention has been described as part of a permanent structure, e.g. a room of a building, the sensor assembly may be installed into a supporting beam of a temporary structure, e.g. a tent.

We claim:

1. A sensor assembly comprising:
a sensor that measures an environmental parameter;
a spool of line, an end of the line connects to the sensor;
an actuator connected to the spool operative to extend and retract the line; and
a controller providing control information to the sensor and the actuator.

2. A sensor assembly as in claim 1 wherein the sensor is a MEMS sensor.

3. A sensor assembly as in claim 1, wherein the sensor includes portable energy storage.

4. A sensor assembly as in claim 3, wherein the portable energy storage is selected from a group that includes a supercap, capacitor, or a battery.

5. A sensor assembly as in claim 1, wherein the environmental parameter is selected from a group that includes light, chemical composition, air speed, air velocity, temperature, humidity, and sound.

6. A sensor assembly as in claim 1, wherein the actuator is a small motor.

7. A sensor assembly as in claim 1, wherein the actuator is a solenoid.

8. A environment measuring system comprising:
an environment having a top surface; and
a movable sensor assembly having a resting position proximate to the top surface.

9. An environment measuring system, as in claim 8, the movable sensor assembly including:
a sensor that measures an environmental parameter;
a spool of line, an end of the line connects to the sensor;
an actuator connected to the spool operative to extend and retract the line; and
a controller providing control information to the sensor and the actuator.

10. A sensor assembly as in claim 9, wherein the sensor is a MEMS sensor.

11. A sensor assembly as in claim 9, wherein the environmental parameter is selected from a group that includes light, chemical composition, air speed, air velocity, temperature, humidity, and sound.

12. A sensor assembly as in claim 9, wherein the actuator is a small motor.

13. A sensor assembly as in claim 9, wherein the actuator is a solenoid controller.

14. A sensor assembly as in claim 9, wherein the sensor includes portable energy storage.

15. A sensor assembly as in claim 14, wherein the portable energy storage is selected from a group that includes a supercap, capacitor, and a battery.

16. A dynamic measuring process comprising:
dynamically positioning a sensor to a selected height, wherein the sensor senses an environmental parameter and has a resting position;
measuring the environmental parameter;
repeating dynamically positioning and measuring to acquire a desired vertical profile of the environmental parameter;
communicating the vertical profile; and
returning the sensor to its resting position.
